(19) United States
(12) Patent Application Publication
(10) Pub. No.: US 2020/0104118 A1
(43) Pub. Date: Apr. 2, 2020

(54) SYSTEMS AND METHODS FOR PROVIDING STAGED UPDATES IN EMBEDDED DEVICES

(71) Applicant: Bose Corporation, Framingham, MA (US)

(72) Inventors: Trevor Lai, Wayland, MA (US); Jonathan Cooper, Newport, RI (US); Sharad Mathur, Lexington, MA (US)

(73) Assignee: Bose Corporation, Framingham, MA (US)

(21) Appl. No.: 16/146,610

(22) Filed: Sep. 28, 2018

(51) Int. Cl. G06F 8/658; G06F 8/656; G06F 8/654; H04L 29/08

(52) U.S. Cl. CPC G06F 8/658; H04L 67/34; G06F 8/654; G06F 8/656

(57) ABSTRACT

An embedded device, a software updating system for an embedded device, and a method for updating software of an embedded device. The method includes activating the embedded device and automatically triggering a software update for the embedded device upon activation of the embedded device. Usage of an operative component of the embedded device is restricted while the software is updating. The embedded device connects to a remote server, which has a staged update stored therein that comprises one or more data packages arranged as a first stage and a second stage. The first stage of the staged update is downloaded and installed. Normal use of the operative component of the embedded device is permitted after installing the first stage. Installation of the second stage is delayed until a later time.

### BACKGROUND

The disclosure relates to software updating systems and related devices and methods, and, particularly, to software updating systems for embedded devices.

### SUMMARY

All examples and features mentioned below can be combined in any technically possible way.

Generally, in one aspect, a method for updating software of an embedded device is provided. The method includes activating the embedded device; automatically triggering a software update for the embedded device upon activation of the embedded device, during which usage of an operative component of the embedded device is restricted; connecting the embedded device to a remote server, the remote server having a staged update stored therein, the staged update comprising one or more data packages arranged as a first stage and a second stage; downloading and installing the first stage of the staged update; permitting use of the operative component of the embedded device after installing the first stage; and delaying installation of the second stage until a later time.

In one example, the method further includes detecting one or more parameters related to the later time and installing the second stage after the one or more parameters are detected. In one example, the second stage is downloaded after the one or more parameters are detected. In one example, the second stage is downloaded as a background process while normal use of the embedded device is being permitted. In one example, the parameters relate to a current time being within a selected time window. In one example, the one or more parameters relate to an idle status of the embedded device.

In one example, the remote server is implemented via cloud-computing. In one example, the method further includes determining whether the staged update is available for the embedded device. In one example, a full update is downloaded and installed if a staged update is not available. In one example, the determining includes comparing a current version of software on the embedded device to a most recent version of software stored at the remote server. In one example, wherein the remote server performs the comparing.

In one example, the operative component includes a speaker, an electronic display, an actuator, or a combination including at least one of the foregoing. In one example, the activating, the automatically triggering, the connecting, the downloading and installing, the permitting, the delaying, or a combination including at least one of the foregoing, is performed by a controller of the embedded device, the controller comprising a communication module, a memory module, and a processor.

Generally, in one aspect, an embedded device is provided. The embedded device includes an operative component configured to provide one or more functions for the embedded device; and a controller comprising a communication module, a memory module, and a processor, the controller configured to automatically trigger a software update upon activation of the embedded device; connect the embedded device to a remote server via the communication module, the remote server having a staged update stored therein, the staged update comprising one or more data packages arranged as a first stage and a second stage; download and install the first stage of the staged update from the remote server; permit use of the operative component of the embedded device after the first stage is installed; and delay installation of the second stage until a later time.

In one example, the embedded device is a speaker system and the operative component is configured to generate sound. In one example, the controller is configured to download the second stage as a background process while the use of the operative component is permitted. In one example, the controller is configured to detect one or more parameters indicative of inactivity of the embedded device and to install the second stage after detecting the one or more parameters. In one example, the controller is configured to download the second stage as a background process while use of the operative component is permitted.

Generally, in another aspect, a software updating system includes a embedded device and a remote server according to the examples herein, wherein the remote server is implemented via cloud-computing. In one example, the remote server is configured to receive a current version of software installed on the embedded device from the embedded device, to compare the current version to a most recent version, and to select the staged update corresponding to the most recent version.

### BRIEF DESCRIPTION OF THE DRAWINGS

FIG. 1 is a block diagram illustrating a software update system for an embedded device according to one example disclosed herein.

FIG. 2 is a flowchart illustrating a method of updating software of an embedded device according to one example disclosed herein.

FIG. 3 is a flowchart illustrating a method of updating software of an embedded device according to another example disclosed herein.

### DETAILED DESCRIPTION

The present disclosure describes various systems and methods for updating software of an embedded device, particularly for providing a staged software update for an embedded device.

The term “embedded device” as used herein is intended to mean an electronic device that is arranged to perform one or more particular functions, and which includes a computer system arranged specifically to facilitate operation of the functions (e.g., as opposed to a general purpose computer such as a personal computer, laptop, smartphone, etc.). Some embedded devices may colloquially be referred to as “smart” devices. Examples of embedded devices include audio equipment (stereo, speaker system, etc.), toys and games (e.g., gaming console, hand-held gaming device, voice-controlled toy, etc.), appliances (refrigerator, coffee machine, oven, etc. with “smart” capabilities), automobiles, etc. In one example, the embedded device is the SoundLink® Revolve™ portable speaker available from Bose Corporation.

In many cases, certain aspects of the software, such as with respect to managing software updates, may be “headless” in that the embedded device lacks a dedicated graphical user interface that enables a user to specifically manage software versions and updates. For example, software updates may be mandatory and/or automatically initiated and completed by the embedded device during normal use and/or before normal use is permitted. A software update may be used to fix bugs, address security vulnerabilities, improve performance, add functions or features, etc. The software may include a hardware support package (HSP), or updates to an operating system, file system, firmware, etc.

In one example, a network-connected embedded device may require its software to be updated upon initial activation by a user before the device can be used for its intended function. For example, this may occur during the initial “out of the box” set up the very first time the device is ever turned on, at set intervals, and/or each time the device is turned on. However, a long software update during an initial setup process and/or each time a device is activated (even on the scale of a few minutes) can result in a frustrating experience for many users, since many users desire immediate use of their devices. On the other hand, an embedded device that does not strictly enforce software updates may be at increased security risk, operate less effectively, be prone to error, etc.

According to the examples disclosed herein, a staged approach for software updates is implemented. In the proposed staged update methodologies, the software update may be separated into separate stages, e.g., based on the deemed criticality (e.g., desirability) of each part of the update. In this approach, the first stage of the update may be downloaded and installed, e.g., in a mandatory and/or automatic manner, in the foreground during initial activation (e.g., during “out of the box” setup or at device startup). Installation of a second stage of the update, e.g., deemed to be of less criticality, can be delayed until a later time. Once the first stage is installed, normal use of the embedded device can be enabled. For example, the second stage may be downloaded in the background while normal use of the device is permitted and installed at a later time, or both the download and installation may be delayed. The second stage may be installed based on detection of one or more parameters that indicate or correspond to user inactivity. For example, in one example the second stage is installed when the device determines the current time to be within a specified time of day (e.g., in the late night/early morning when most users are typically asleep).

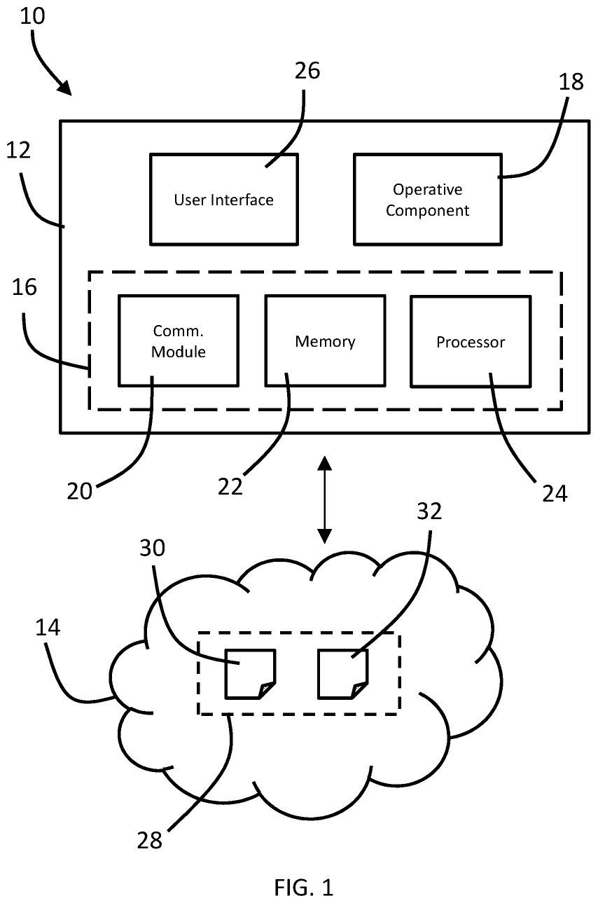

FIG. 1 depicts a software updating system 10 having an embedded device 12 in communication with a remote server 14 according to one example disclosed herein. The embedded device 12 may include a controller 16 and an operative component 18 that each takes any desired form, type, make, model, arrangement, or configuration that enables the embedded device 12 to provide one or more desired functions. For example, if the embedded device 12 is a loudspeaker or other piece of audio-producing equipment, then the operative component 18 may be an electro-acoustic transducer. As another example, if the embedded device 12 is a refrigerator, then the operative component 18 may be a water dispenser, ice maker, heat pump, integrated display panel, etc. Those of ordinary skill in the art will recognize any number of other embedded devices that have a corresponding array of different possible operative components.

The controller 16 may include any suitable computer software and/or hardware useful for implementing the features and functionality described herein. For example, the controller 16 may include a communication module 20, a memory module 22, and a processor 24. These components may be discrete components in data communication, and/or integrated together. It is to be appreciated that the remote server 14 may include any combination of computing components and resources, e.g., akin to the communication module 20, the memory module 22, and the processor 24 for enabling the remote server to provide the features and functionality disclosed herein.

The communication module 20 is configured to establish a wired or wireless connection between the embedded device 12 and the remote server 14 (e.g., implemented via cloud-computing). The communication module 20 may be any module, device, transceiver, radio, network card, or other means capable of enabling the transmission and/or reception of a wired or wireless communication signal utilizing any corresponding wired or wireless technology (or combinations thereof), including but not limited to Wi-Fi (e.g., IEEE 802.11), Bluetooth, cellular, Ethernet, etc.

The memory module 22 may take any suitable form or forms, including volatile memory, such as random access memory (RAM), or non-volatile memory such as read only memory (ROM), flash memory, a hard disk drive (HDD), a solid state drive (SSD), or other data storage media. The memory module 22 may be used by the processor 24 for the temporary storage of data during its operation. Data and software, such as the algorithms, operating systems, file systems, firmware, or other software desired to be updated, as well as the downloaded file packages from which the updates are installed, may be stored in the memory module 22. The processor 24 may take any suitable form, such as a microcontroller, plural microcontrollers, circuitry, a single processor, or plural processors configured to execute software instructions.

A user interface 26 may also be included that enables a user to issue commands or influence control over operation of the embedded device 12 (e.g., turn the device 12 on/off, initiate a mode of operation, change a mode of operation, etc.), and/or to receive feedback regarding the status of the embedded device 12 (e.g., whether the device 12 is turned on, which mode of operation is selected, whether the device 12 is communicably connected to a network, etc.). The user interface 26 may be a physical mechanism, such as a button, switch, toggle, lever, mouse, keyboard, touchscreen, capacitive sensor, etc. The user interface 26 may additionally or alternatively include a display panel or screen on which a graphical user interface is visually displayed. Lights, colors, sounds, haptic feedback, etc. may also be utilized by the user interface 26. It is also to be appreciated that the user interface 26 may be implemented by a remote device, such as an infrared remote, or via a software application stored on a smartphone, tablet, or other computing device in communication with the embedded device 12, e.g., via the communication module 20.

The remote server 14 includes a software update 28, e.g., an installable data package to update one or more files, applications, or other pieces of software installed on the embedded device 12. The update 28 may enable new features to be set up and implemented by the embedded device 12. In accordance with the examples described herein, the software update 28 includes a first stage 30 and a second stage 32, which can each include data packages or files that are separately downloadable and installable by the embedded device 12 at different times. For example, the first stage 30 may relate to more basic functionality and features, critical bug fixes, security updates, etc., while the second stage 32 may relate to advanced functionality, performance tweaks, etc. The second stage 32 of the software update 28 may, as one example, include an improved algorithm or other files utilized by the embedded device 12 to better interpret and/or implement voice commands received from a user.

One example of a staged update is provided in Table 1, below. In this example, there are six data packages that are tagged as being relevant to the first stage of the update, and a seventh data package that is relevant to the second stage of the update. As summarized in Table 1, the overall time to download and install just stage 1 of the update is significantly less than the time to download and install the complete update. For example, package 7 may be a hardware support package that improves behind the scenes functionality such as improved intelligence and algorithms, while packages 1-6 may contain more critical components such as bug fixes and security updates, and forward-facing aspects such as user interface improvements. In this way, it is ensured that the embedded device has use of the most desired features and functionality without requiring a user to undergo a lengthy update process.

TABLE 1

| Package | Stage | Download Time (min) | Install Time (min) |
|---|---|---|---|
| 1 | 1 | 00:42.4 | 00:48.3 |
| 2 | 1 | 00:00.0 | 00:28.3 |
| 3 | 1 | 00:04.8 | 00:07.0 |
| 4 | 1 | 00:00.1 | 00:10.7 |
| 5 | 1 | 00:02.6 | 00:08.5 |
| 6 | 1 | 00:00.9 | 00:59.7 |
| STAGE 1 SUBTOTAL | | 00:50.7 | 02:43.0 |
| 7 | 2 | 00:41.1 | 05:09.7 |

| | | |
|---|---|---|
| STAGE 2 SUBTOTAL | 00:41.1 | 05:09.7 |
| APPROX. TOTAL | 01:32.0 | 07:53.0 |

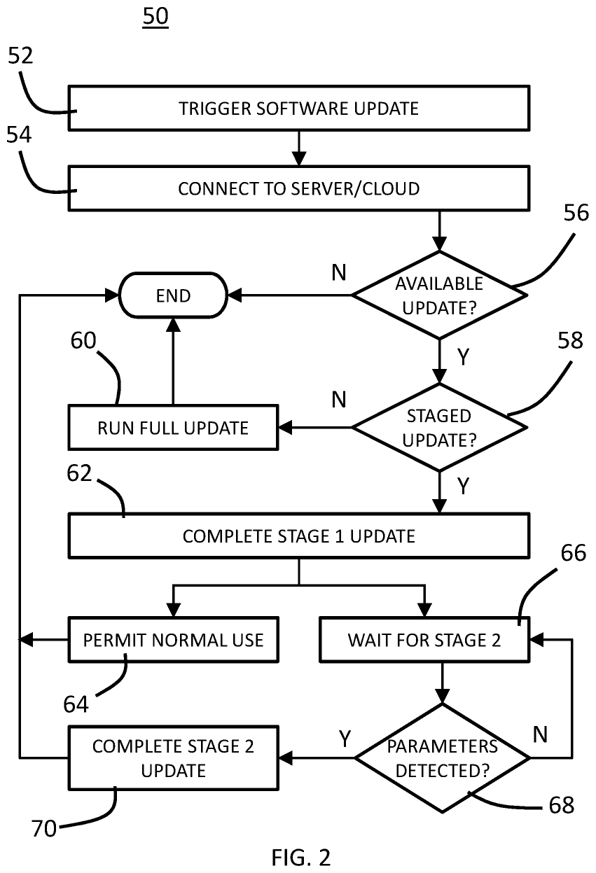

A method 50 for updating the software of an embedded device (e.g., the embedded device 12) according to one example is illustrated in FIG. 2. At step 52, the software update is triggered, e.g., automatically due to activation of the embedded device. For example, this may include turning the device on for the initial “out of the box” setup. As other examples, the step 52 may occur at preset intervals, each time the device is turned on, each time the device connects to a remote server (e.g., the server 14) or when the device is commanded to take a particular action (e.g., during normal use) that may be affected by an update (e.g., by a user using the user interface 26). In particular, triggering of an update at step 52 may be mandatory and/or automatic upon using the embedded device (e.g., during initial setup after turning it on for the first time), with use of the device restricted until after installation of the relevant updates has completed (i.e., a “foreground” update). That is, a foreground update is visible to the user. A foreground update may require the user to wait until the update is completed before normal use of the embedded device is permitted, e.g., by temporarily disabling the ability to receive commands and/or occupying elements of the user interface such as a graphical user interface.

At step 54, the embedded device connects (e.g., via the communication module 20) to a remote server (e.g., the remote server 14), which may be implemented in the cloud. For example, a user performing an initial out of the box setup of an embedded device may be guided, e.g., via visual or audio prompts presented by a user interface (e.g., the user interface 26) to connect the embedded device to a network (e.g., to the remote server 14), in order to check for updates, register the embedded device to a user account, etc. The remote server can determine or identify the version of the software currently installed on the embedded device to see if there are any available updates (e.g., the software update 28) at step 56. If no updates are available (e.g., the software version of the embedded device matches the most recent software version available on the remote server), then the method 50 may end, thereby enabling normal use of the device by a user.

If an update in step 56 is determined to be available, then it can next be determined whether or not the update is a staged update at step 58. If the update is not a staged update, then at step 60 a full update can be completed, before the method 50 ends. If a staged update is available, then the step 58 may proceed to step 62 at which a first stage of the update (e.g., the first stage 30) is downloaded and installed. Once the first stage is installed, normal use of the device may be permitted at step 64.

Optimally, the staged update is predetermined or preconfigured by a remote device, such as a remote server implemented via cloud-computing. It is to be appreciated that the embedded device may determine for itself whether or not an update is needed, or the determination may be made by a remote device, such as the remote server or a connected application of a mobile computing device. In one example, the remote server is owned or managed by the manufacturer of the embedded device and controls and manages all software updates. The embedded device may be arranged to accept any determination made by the remote server, and/or to verify whether an update is applicable using its own internal logic. As discussed herein, the timing of the installation of the updates can be controlled by the embedded device. If the remote server controls the updates, then the software versions and update rules for the embedded devices can be easily modified over time as needed. In one example, the embedded device may provide its current software version to the remote server (e.g., via a URLQuery or other process), which the remote server analyzes to see if the remote server has any update packages that will update the current software version of the embedded device to a more recent software version. The update can be directly sent by the remote server or a download link can be provided to the embedded device.

Concurrently, while normal use of the device is being permitted at step 64, the embedded device may wait for an appropriate time to install a second stage of the software update (e.g., the second stage 32) at step 66. Step 66 may include downloading and/or preparing for installation all or a part of the second stage of the update as a background process for the embedded device (i.e., which does not overly interfere with normal use of the embedded device). That is, a background update is not readily visible to, or detectable by, a user using the embedded device. In a background update, the embedded device may schedule the update to be completed at a later time.

Step 66 may continue or repeat as necessary with respect to step 68, at which it is determined whether one or more preselected parameters are detected, e.g., parameters indicative of user inactivity or which otherwise trigger the installation of the second stage of the update. That is, if the selected parameters are not detected or determined, then the embedded device can continue to wait at step 66. For example these parameters may include determining whether the current time is within a preset time window (e.g., during which a user is expected to not be using the embedded device). For example, in one example the time range is determined between about 2:00 AM and 5:00 AM, or some other time when users are typically asleep. As another example, the embedded device may wait until it has been idle (e.g., has not received a user command or performed an action) for a set period of time, such as twenty minutes, thirty minutes, an hour, or some other length of time. As another example, the embedded device may detect when it has entered a certain mode or status, such as a network standby mode. As one example, if the embedded device has access to a user's electronic calendar (e.g., stored in the memory 22, or stored in the server 14 or other remote device and accessible via the communication module 20), then the embedded device may select a time that does not overlap with any scheduled events on the user's calendar. Those of ordinary skill in the art will recognize a variety of other parameters (or combinations of parameters) that could be monitored, detected, or determined to facilitate installation of the second stage of the update at a time that is unobtrusive to the user.

Once preset parameters are detected, then the second stage of the update may be completed at step 70. If the data package was already downloaded in the background, then the step 70 may include just the installation of the update. If the data package was not previously downloaded, then the step 70 may include both downloading and installation. Once the second stage of the update is installed, the embedded device can function normally, and the method 50 may end.

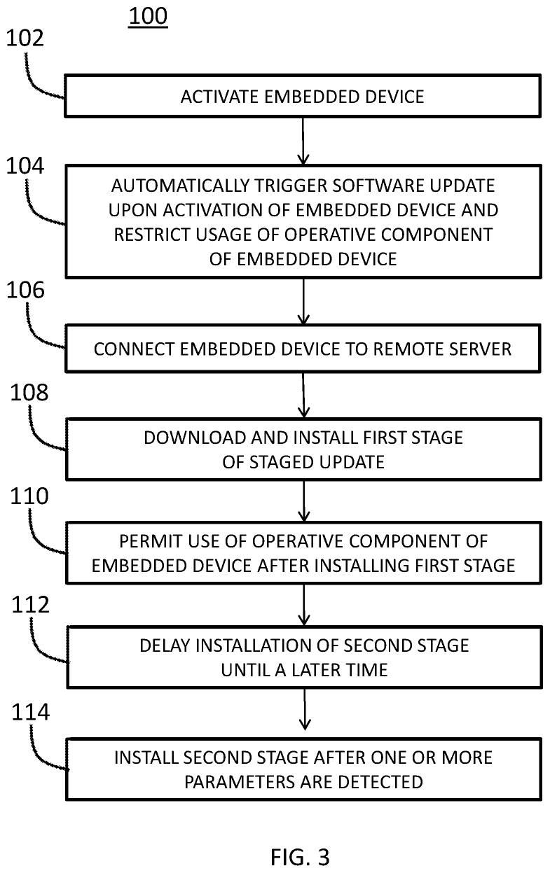

A method 100 for updating the software of an embedded device (e.g., the embedded device 12) according to another example is illustrated in FIG. 3. In step 102, the embedded device is activated. In step 104, a software update for the embedded device is automatically triggered upon activation of the embedded device, during which usage of an operative component of the embedded device is restricted. In step 106, the embedded device is connected to a remote server, the remote server having a staged update stored therein, the staged update comprising one or more data packages arranged as a first stage and a second stage. In step 108, the first stage of the staged update is downloaded and installed on the embedded device. In step 110, use of the operative component of the embedded device is permitted after installing the first stage. In step 112, installation of the second stage is delayed until a later time. In step 114, one or more parameters are detected related to the later time and the second stage is installed on the embedded device after the one or more parameters are detected.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

1. A method for updating software of an embedded device, comprising:
activating the embedded device;
automatically triggering a software update for the embedded device upon activation of the embedded device, during which usage of an operative component of the embedded device is restricted;
connecting the embedded device to a remote server, the remote server having a staged update stored therein, the staged update comprising one or more data packages arranged as a first stage and a second stage;
downloading and installing the first stage of the staged update;
permitting use of the operative component of the embedded device after installing the first stage;
delaying installation of the second stage until a later time;
detecting one or more parameters related to the later time, wherein the parameters are indicative of inactivity of the embedded device; and
installing the second stage after the one or more parameters are detected.

2. (canceled)

3. The method of claim 1, wherein the second stage is downloaded after the one or more parameters are detected.

4. The method of claim 1, wherein the second stage is downloaded as a background process while normal use of the embedded device is being permitted.

5. The method of claim 1, wherein the parameters relate to a current time being within a selected time window.

6. The method of claim 1, wherein the one or more parameters relate to an idle status of the embedded device.

7. The method of claim 1, wherein the remote server is implemented via cloud-computing.

8. The method of claim 1, further comprising determining whether the staged update is available for the embedded device.

9. The method of claim 8, wherein a full update is downloaded and installed if a staged update is not available.

10. The method of claim 8, wherein the determining includes comparing a current version of software on the embedded device to a most recent version of software stored at the remote server.

11. The method of claim 10, wherein the remote server performs the comparing.

12. The method of claim 1, wherein the operative component is a speaker, an electronic display, an actuator, or a combination including at least one of the foregoing.

13. The method of claim 1, wherein the activating, the automatically triggering, the connecting, the downloading and installing, the permitting, the delaying, or a combination including at least one of the foregoing, is performed by a controller of the embedded device, the controller comprising a communication module, a memory module, and a processor.

14. An embedded device comprising:
an operative component configured to provide one or more functions for the embedded device; and
a controller comprising a communication module, a memory module, and a processor, the controller configured to:
automatically trigger a software update upon activation of the embedded device;
connect the embedded device to a remote server via the communication module, the remote server having a staged update stored therein, the staged update comprising one or more data packages arranged as a first stage and a second stage;
download and install the first stage of the staged update from the remote server;
permit use of the operative component of the embedded device after the first stage is installed;
delay installation of the second stage until a later time;
detect one or more parameters related to the later time, wherein the parameters are indicative of inactivity of the embedded device; and
install the second stage after the one or more parameters are detected.

15. The embedded device of claim 14, wherein the embedded device is a speaker system and the operative component is configured to generate sound.

16. The embedded device of claim 14, wherein the controller is configured to download the second stage as a background process while the use of the operative component is permitted.

17. (canceled)

18. (canceled)

19. A software updating system comprising the embedded device and the remote server of claim 14, wherein the remote server is implemented via cloud-computing.

20. The system of claim 19, wherein the remote server is configured to receive a current version of software installed on the embedded device from the embedded device, to compare the current version to a most recent version, and to select the staged update corresponding to the most recent version.

21. The method of claim 1, wherein the one or more parameters relate to a mode of the embedded device.

22. The method of claim 21, wherein the mode of the embedded device is a network standby mode.

23. The method of claim 1, wherein the one or more parameters relate to an electronic calendar accessible by the embedded device.
